(19) United States
(12) Patent Application Publication
(10) Pub. No.: US 2013/0170194 A1
(43) Pub. Date: Jul. 4, 2013

(54) LAMPHOLDER AND LUMINAIRE

(71) Applicant: Takeshi Osada, Yokosuka-shi (JP)

(72) Inventor: Takeshi Osada, Yokosuka-shi (JP)

(73) Assignee: TOSHIBA LIGHTING & TECHNOLOGY CORPORATION, Kanagawa (JP)

(21) Appl. No.: 13/820,063

(22) PCT Filed: Sep. 27, 2011
(86) PCT No.: PCT/JP2011/072118

§ 371 Date: Feb. 28, 2013

(30) Foreign Application Priority Data
Sep. 27, 2010 (JP) 2010-215983
Dec. 29, 2010 (JP) 2010-294399

(51) Int. Cl. F21V 21/14

(52) U.S. Cl. CPC F21V 21/14
USPC 362/217.17

(57) ABSTRACT

A straight tube type lamp is mounted on a lampholder by inserting a pair of L-shaped lamp pins and rotating the same. The lampholder includes a lampholder body, and a rotating member and a pair of terminals to be arranged in the lampholder body. The lampholder body is provided with a front portion facing the straight tube type lamp when the straight tube type lamp is mounted. An insertion port which allows insertion of the pair of lamp pins is provided on a surface intersecting the front portion. The front portion is provided with an opening portion communicating with the insertion port and allowing the pair of lamp pins to rotate. A wall portion configured to restrict insertion of the lamp pins into the opening portion in a state in which the straight tube type lamp is separated from the front portion with respect to a predetermined mounting position is provided at an edge portion of the opening portion facing the insertion port.

### TECHNICAL FIELD

Embodiments of the present invention relates to a lampholder configured to allow a straight tube type lamp to be mounted thereon by inserting a pair of L-shaped lamp pins thereof having a pair of leg portions and a projecting portions extending from distal ends of the leg portions outward in a direction away from each other and rotating the same, and a luminaire using the lampholder.

### BACKGROUND ART

In general, a luminaire using a straight tube type fluorescent lamp including G13-type caps each having a pair of column-shaped lamp pins projecting therefrom at both ends thereof, and lampholders for connecting the fluorescent lamp is widely used.

There is a lampholder employing a rotational mounting system, and having a configuration that allows a pair of lamp pins of a straight tube type fluorescent lamp to be electrically connected to a pair of terminals arranged in the lampholder and to be held thereby by inserting the pair of lamp pins from the distal end side of the lampholder and arranging the straight tube type fluorescent lamp on the front side of the lampholder, and then rotating the fluorescent lamp with respect to the lampholder.

There is also proposed a straight tube type lamp using LED elements. The straight tube type lamps of this type include a straight tube type lamp provided with a cap having a pair of L-shaped lamp pins in addition to the straight tube lamp using the G13-type cap in the same manner in the related art.

### CITATION LIST

### Patent Literature

PTL 1: Japanese Laid-open Paten Publication No. 2003-100402

PTL2: Japanese Registered Utility Model No. 3152509

SUMMARY OF INVENTION

### Technical Problem

However, sufficient deliberation is not performed about mounting of the straight tube type lamp having the pair of L-shaped lamp pins.

A problem that the present invention is to solve is to provide a lampholder capable of guiding a straight tube type lamp having a pair of L-shaped lamp pins to a predetermined mounting position, and a luminaire using the lampholder having such a configuration.

### Solution to Problem

A straight tube type lamp is mounted on a lampholder of the embodiment by inserting a pair of L-shaped lamp pins and rotating the same. The lampholder includes a lampholder body, and a rotating member and a pair of terminals to be arranged in the lampholder body. The lampholder body is provided with a front portion facing the straight tube type lamp when the straight tube type lamp is mounted. An insertion port which allows insertion of the pair of lamp pins is provided on a surface intersecting the front portion. The front portion is provided with an opening portion communicating with the insertion port and allowing the pair of lamp pins to rotate. A wall portion configured to restrict insertion of the lamp pins into the opening portion in a state in which the straight tube type lamp is separated from the front portion with respect to a predetermined mounting position is provided at an edge portion of the opening portion facing the insertion port.

### BRIEF DESCRIPTION OF DRAWINGS

FIG. 1 is a perspective view of a first embodiment in which a cover of a lampholder is removed and viewed from the back surface side.

FIG. 2 illustrates an example of mounting of a straight tube type lamp with respect to the same lampholder, in which (a) is a cross-sectional view of a state in which the straight tube type lamp is in a predetermined mounting position, (b) is a cross-sectional view illustrating a state in which the straight tube type lamp is separated from a front surface of a lampholder body with respect to the predetermined mounting position thereof, and (c) is a cross-sectional view illustrating another state in which the straight tube type lamp is separated from the front surface of the lampholder body with respect to the predetermined mounting position thereof.

FIG. 3 is a perspective view illustrating parts of the same lampholder and the straight tube type lamp.

FIG. 4 is a perspective view of the same lampholder in the disassembled state.

FIG. 5 is a perspective view of the straight tube type lamp to be connected to the same lampholder.

FIG. 6 is a side view of a luminaire in which the same lampholder is used.

FIG. 7 is a perspective view of the same luminaire.

FIG. 8 is a cross-sectional view of a lampholder of a second embodiment.

FIG. 9 is a cross-sectional view of the same lampholder.

FIG. 10 is a perspective view illustrating parts of the same lampholder and a straight tube type lamp.

FIG. 11 is a perspective view of the same lampholder in the disassembled state.

### DESCRIPTION OF EMBODIMENTS

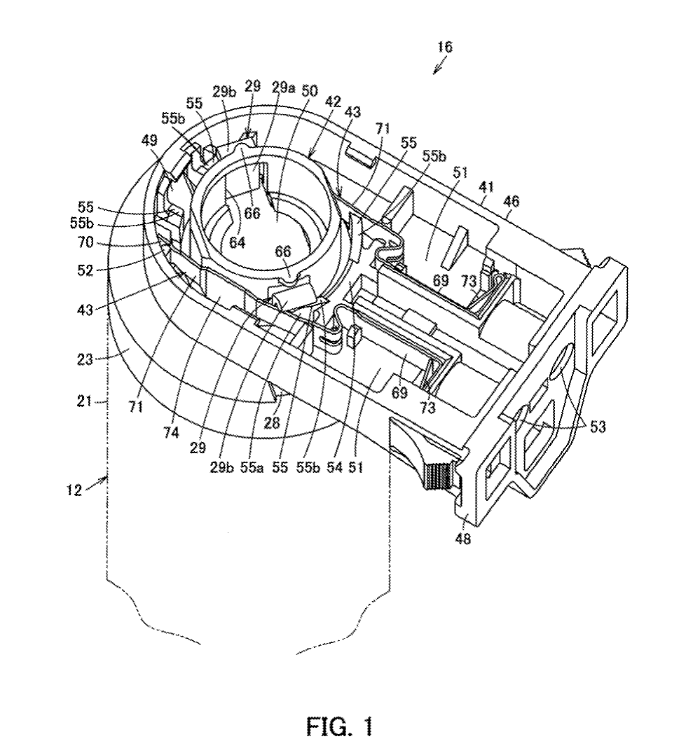

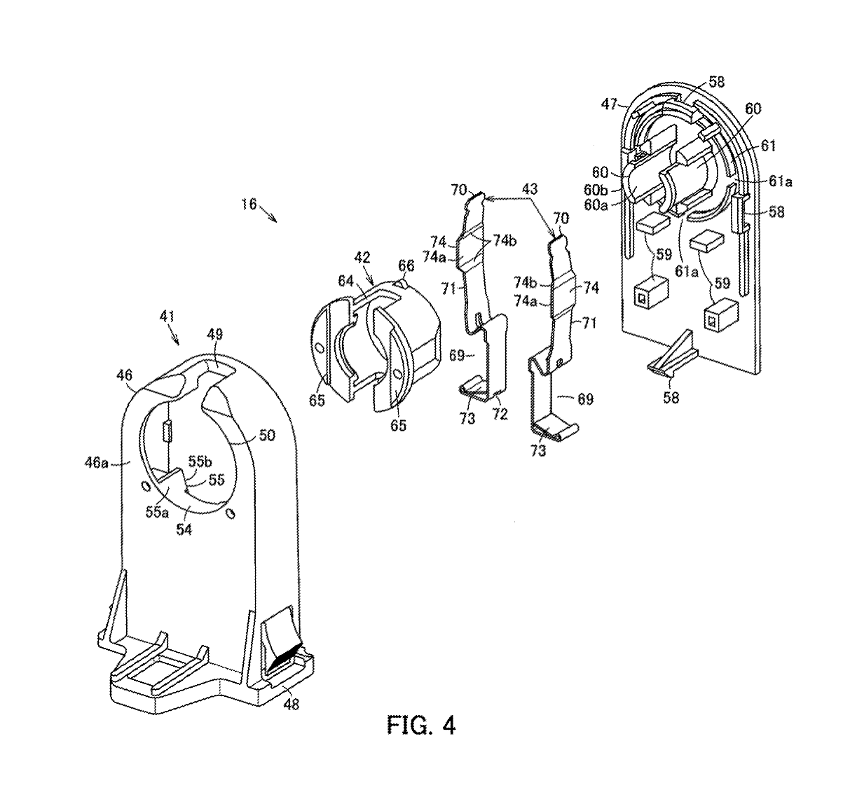

Referring now to the drawings, a first embodiment will be described with reference to FIG. 1 to FIG. 7.

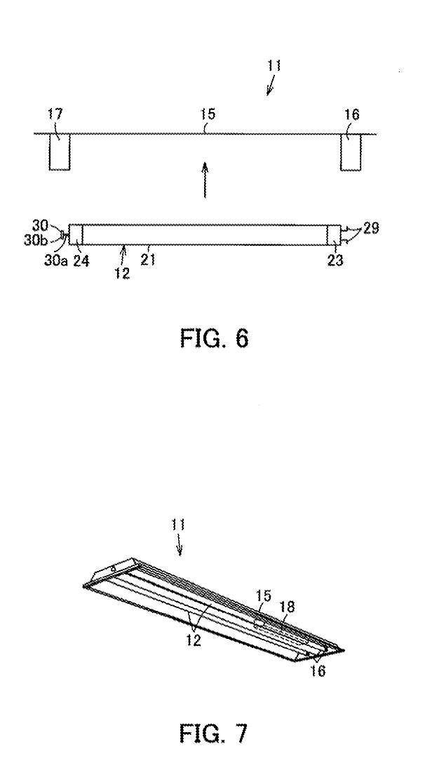

FIG. 6 and FIG. 7 illustrate a luminaire 11, which is a recessed luminaire of a two straight tube type fluorescent lamp type, and two straight tube type lamps 12 are used in the luminaire 11.

The luminaire 11 includes an elongated luminaire body 15 of a lower side opening portion type which is configured to be installed in a recessed ceiling surface, two sets of lampholders 16, 17 arranged at both ends of the luminaire body 15 in the longitudinal directions so as to oppose each other and to which end portions of the respective straight tube type lamps 12 are mounted, and a lighting apparatus 18 arranged in the luminaire body 15 and configured to light the straight tube type lamps 12. The lampholder 16 on one end side to which one end sides of the straight tube type lamps 12 are mounted corresponds to a power supply side, and the lampholder 17 on the other end side to which the other end sides of the straight tube type lamps 12 are mounted corresponds to a non-power supply side and is an earth side. Each of the lampholders 17 on the earth side serves either both as an earth connection and as a mount of the straight tube type lamp 12, or only as a mount of the straight tube type lamp 12, and both cases are possible.

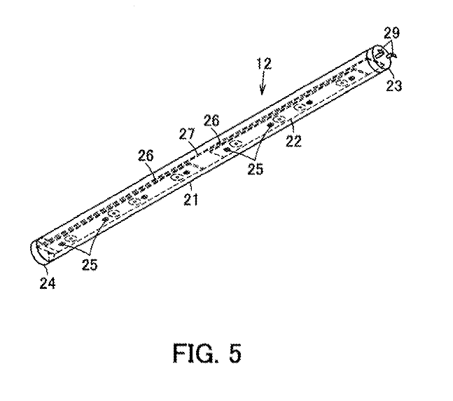

As illustrated in FIG. 5, the straight tube type lamp 12 includes a translucent cover 21, which is a tube formed into a straight tube shape having approximately the same tube length and the tube diameter as a light-emitting tube of the straight tube type fluorescent lamp, a light-source unit 22 housed in the translucent cover 21, and caps 23, 24 provided respectively at both end portions of the translucent cover 21. The cap 23 on one end side of the straight tube type lamp 12 corresponds to a power supply side, which is mounted on the lampholder 16 on the power supply side, and the cap 24 on the other end side of the straight tube type lamp 12 corresponds to an earth side, which is a non-power supply side which is mounted on the lampholder 17 on the earth side. The cap 24 on the earth side serves either as both an earth connection and a mount with respect to the lampholder 17, or only as a mount with respect to the lampholder 17, and both cases are possible.

The light-source unit 22 includes a plurality of substrates 26 on which a plurality of semiconductor light-emitting elements 25 such as LED elements or EL elements are mounted, and a mounting plate 27 on which these substrates 26 are mounted. In the case of the LED elements, a method of mounting a plurality of SMD Surface Mount Device) packages each provided with a connecting terminal formed by mounting LED chips on the substrate 26 or a COB (Chip On Board) method in which a plurality of. LED elements are mounted on the substrate 26 is used as a method of mounting the semiconductor light-emitting elements 25.

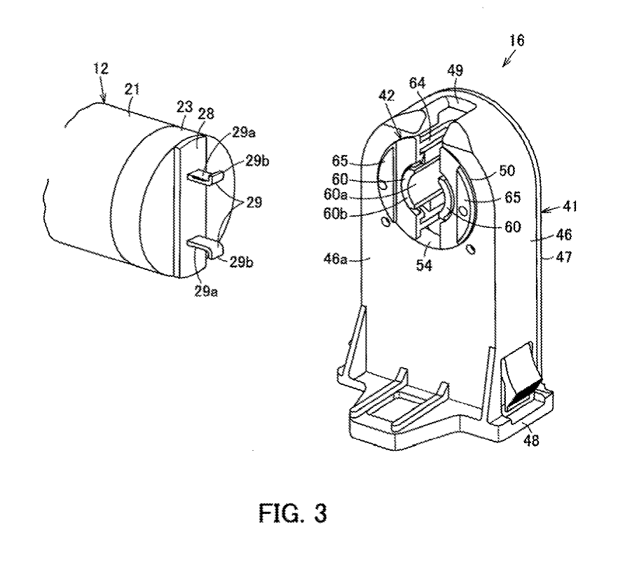

As illustrated in FIG. 3, an end surface of the cap 23 on the power supply side is formed with a projecting ridge portion 28 projecting along the radial diameter, and a pair of lamp pins 29 electrically connected to the light-source unit 22 project from the projecting ridge portion 28. The lamp pins 29 are each formed of a flat plate having a square shape in cross section, and are formed by bending into an L-shape including a leg portion 29a projecting along the longitudinal direction of the straight tube type lamp 12 and a projecting portion 29b projecting outward from a distal end of the leg portion 29a in the direction away from the other leg portion 29a. Then, the plate thickness of the lamp pin 29 is 1 mm, the distance between centers of the leg portions 29a of the pair of lamp pins 29 is 16 mm, and the distance between the opposing leg portions 29a of the pair of lamp pins 29 is 15 mm. In contrast, in the case of the G13 type cap, the diameter of the pair of the lamp pins is 2.29 to 2.67 mm, the distance between centers of the pair of lamp pins is 12.7 mm, and the distance between outsides of the pair of lamp pins is 15.17 mm. Therefore, the pair of lamp pins 29 of the cap 23 on the power supply side have a different shape from the pair of lamp pins of the G13-type cap and have a larger distance therebetween than the distance between the pair of lamp pins of the G13-type cap, and hence have no compatibility with the G13-type cap.

As illustrated in FIG. 6, an earth pin 30 projects from an end surface of the cap 24 on the earth side at an axial center of the tube. The earth pin 30 includes a column-shaped leg portion 30a projecting from the cap 24 and an oval-shaped (ellipsoidal-shaped) holding portion 30b provided at a distal end of the leg portion 30a.

In the straight tube type lamp 12, the direction in which the pair of lamp pins 29 are arranged matches the longitudinal direction of the holding portion 30b of the earth pin 30, and a surface parallel to these directions and a light-emitting surface of the semiconductor light-emitting element 25 of the light-source unit 22 extend in parallel to each other. In other words, the straight tube type lamp 12 is provided so that light from the light-emitting surface of the semiconductor light-emitting element 25 of the light-source unit 22 can be irradiated in a predetermined direction of irradiation in a state in which the straight tube type lamp 12 is mounted correctly between the lampholders 16, 17.

As illustrated in FIG. 6, a rotational mounting system for mounting the straight tube type lamp 12 to a predetermined mounting position by inserting the pair of lamp pins 29 and the, earth pin 30 from distal end surfaces of the lampholders 16, 17 to a predetermined mounting position and rotating the straight tube type lamp 12 by 90° about a tube axis thereof is employed.

Subsequently, FIG. 1 to FIG. 4 illustrate the lampholder 16 on the power supply side. The lampholder 16 includes a lampholder body 41, and a rotating member 42 and a pair of terminals 43 to be arranged in the lampholder body 41. In the description given below, the side of the lampholder 16 which is mounted on the luminaire body 15 is referred to as a proximal end, the side opposite thereto is referred to as a distal end, a surface opposing the end surface of the straight tube type lamp 12 at the time of mounting is referred to as a front surface, the side opposite thereto is referred to as a back surface, portions between the front surface and the back surface are referred to as side surfaces, and a direction opposite to the front surface of the lampholder 16 is referred to as rear.

The lampholder body 41 is formed of synthetic resin having insulating properties and includes a case 46 having an opening on the back surface side, and a cover 47 mounted on the back surface of the case 46.

A mounting portion 48 which is mounted on the luminaire body 15 is provided on the proximal end of the case 46, an insertion port 49 which allows insertion of the pair of lamp pins 29 of the straight tube type lamp 12 is formed on the distal end surface of the case 46, and a front portion 46a of the case 46 is formed with a circular opening portion 50 communicating with the insertion port 49 and allowing rotation of the leg portion 29a of the pair of lamp pins 29 inserted from the insertion port 49.

A pair of terminal holding portions 51 configured to hold the proximal end side of the pair of terminals 43 are formed in the case 46, and a pair of terminal holding portions 52 configured to hold the distal end side of the pair of terminals 43 are also formed in the case 46. Electric cable insertion holes 53 communicating with the respective terminal holding portions 51 are formed at the proximal end of the case 46.

In the case 46, a wall portion 54 is formed on the side opposite to the insertion port 49 at the distal end at an edge portion of the opening portion 50 opposing the insertion port 49 so as to project vertically toward the rear. The wall portion 54 is configured to allow one of the lamp pins 29 inserted from the insertion port 49 first to enter the back surface side of the wall portion 54 to cause the leg portion 29a to abut against the wall portion 54, and allow the straight tube type lamp 12 to be inserted to a predetermined position of insertion with respect to the lampholder 16 in a state in which the straight tube type lamp 12 is at the predetermined mounting position with respect to the lampholder 16 and, in contrast, allow the distal end of the projecting portion 29b of one of the lamp pins 29 inserted from the insertion port 49 first abuts against the wall portion 54 and restrict the straight tube type lamp 12 from being inserted into the predetermined position of insertion of the lampholder 16 in a state in which the straight, tube type lamp 12 is significantly separated from the front surface of the lampholder body 41 of the lampholder 16 with respect to the predetermined mounting position thereof.

Furthermore, inclined portions 55 projecting and inclining rearward of the case 46 corresponding to the direction of rotation of the straight tube type lamp 12 when the straight tube type lamp 12 is mounted (hereinafter, referred to as a direction of rotation for mounting) are provided at four positions on an edge portion of the opening portion 50 at positions on both sides of an area of insertion of the lamp pins 29 from the insertion port 49, that is on both sides of the wall portion 54 and on both sides of the insertion port 49 in the case 46. The inclined portions 55 each include a rib 55a curving along an inner peripheral edge of the opening portion 50 and projecting vertically rearward of the case 46 and an inclined surface 55b formed on the back surface side of the rib 55a. The inclined surface 55b is inclined so as to project rearward as it goes away from the positions of the wall portion 54 and the insertion port 49 in the direction of rotation for mounting.

The inclined portions 55 are formed in areas where the projecting portions 29b of the pair of lamp pins 29 which are inserted into the opening portion 50 from the insertion port 49 and rotated therein can run on. One end sides of the inclined portions 55 on which the rearward projecting dimension is the smallest are the same as the rearward projecting dimension of the wall portion 54, so that the projecting portions 29b of the pair of the lamp pins 29 of the straight tube type lamp 12 inserted into the predetermined position of insertion with respect to the lampholder 16 can run on. The other end sides of the inclined portions 55 on which the rearward projecting dimension is the largest are configured to project rearward from the position of back surface side edges of the terminals 43 held by the terminal holding portions 51, 52 in the case 46 and be capable of guiding the projecting portions 29b of the lamp pins 29 to the back surface sides of the terminals 43.

A plurality of locking portions 58 to be locked by the case 46 in a state of closing the back surface of the case 46 are formed on the front surface of the cover 47, and a plurality of holding projections 59 positioning and holding the respective terminals 43 with respect to the case 46 are formed so as to project therefrom. In addition, a pair of supporting portions 60 which rotatably support the rotating member 42 are formed on the front surface of the cover 47 at positions concentric to the opening portion 50 of the case 46 so as to project therefrom and a guide wall 61 is formed along the peripheries of the supporting portions 60 so as to project therefrom. Groove portions 60a which allow passage of the lamp pins 29 are formed between the pair of supporting portions 60, and claw portions 60b which lock the rotating member 42 rotatably supported at distal ends of the pair of supporting portions 60 are formed so as not to come apart. The guide wall 61 is formed with notched portions 61a at every 90° for providing a tactile feedback at a predetermined rotational position to the rotating member 42,

The rotating member 42 is formed of a synthetic resin having insulating properties, and is formed into a cylindrical shape to be rotatably fitted on the periphery of the supporting portion 60 of the cover 47. Groove portions 64 which allow passage of the lamp pins 29 are formed at positions closer to the front of the rotating member 42 along the radial direction,

A front portion of the rotating member 42 is rotatably arranged in the opening portion 50 of the case 46, and a pair of fitting projections 65 projecting from the font surface of the case 46 so as to allow slide-fitting of the projecting ridge portion 28 of the cap 23 of the straight tube type lamp 12 are formed on the front surface of the rotating member 42 so as to project therefrom.

A rear portion of the rotating member 42 is arranged between the supporting portions 60 and the guide wall 61, and a pair of projecting portions 66 are formed at two positions on an outer peripheral surface of the rear portion of the rotating member 42 and parallel to the groove direction of the groove portions 64 so as to project therefrom. The projecting portions 66 engage the notched portions 61a of the guide wall 61 and provide the tactile feedback to the rotational position of the rotating member 42, and part of the rotating member 42 resiliently deforms in the periphery of the projecting portion 66, so that the projecting portions 66 come into contact with an inner peripheral surface of the guide wall 61 and slide on the inner peripheral surface, whereby the rotation of the rotating member 42 is allowed.

The terminals 43 are formed of a leaf spring having electrical conductivity and each include an electric line connecting portion 69 arranged on the terminal holding portions 51 on the proximal end side of the case 46, a distal end portion 70 arranged on the terminal holding portions 52 on the distal end side of the case 46, and a connecting plate portion 71 connected to the lamp pins 29 formed on an intermediate portion between the electric line connecting portion 69 and the distal end portion 70.

The electric line connecting portion 69 includes an insertion hole 72 which allows insertion of an electric cable inserted from the electric cable insertion holes 53, and a locking strip 73 electrically connected to the electric cable inserted into the insertion hole 72 and configured to prevent the electric cable from coming apart.

The connecting plate portion 71 is formed with a terminal holding portion 74 depressed on a contact surface side with which the leg portion 29a of the lamp pin 29 comes into contact. The terminal holding portion 74 includes a depressed surface 74a and a pair of inclined surfaces 74b at both ends of the depressed surface 74a. The terminal 43 is configured so that the both inclined surfaces 74b of the terminal holding portion 74 come into contact at two points with corner portions at two positions on the outside of the leg portion 29a having a square shape in cross section of the lamp pins 29 in a state of being connected to the lamp pins 29.

The width of the terminal holding portion 74 located in an intermediate portion of the connecting plate portion 71 is formed to be wider than the width of the electric line connecting portion 69 and the width of the distal end portion 70. Edge portions on both sides of the inclined surfaces 74b of the connecting plate portion 71 are formed into an inclined shape so as to connect both side edges of the wide depressed surface 74a and both side edges of portions on the both end sides of the connecting plate portion 71 continuously.

As regards the lampholder 17 on the earth side, the earth pin 30 of the straight tube type lamp 12 is inserted into the lampholder 17 along the longitudinal direction of the holding portion 30b of the earth pin 30, and the straight tube type lamp 12 is rotated by 90° about the tube axis thereof, so that the longitudinal direction of the holding portion 30b of the earth pin 30 turns sideways with respect to the direction of insertion into the lampholder 17, and the earth pin 30 is electrically connected to the terminal arranged in the lampholder 17 and is supported by the lampholder 17.

The lighting apparatus 18 illustrated in FIG. 7 is configured to receive a supply of commercial AC power source, convert an AC power to a DC power, and supply the DC power to the light-source unit 22 through the pair of terminals 43 of the lampholder 16 on the power supply side and the pair of lamp pins 29 of the straight tube type lamp 12.

Subsequently, in the luminaire 11 configured in this manner, when connecting the straight tube type lamp 12, as illustrated in FIG. 6, the straight tube type lamp 12 is mounted between the lampholders 16, 17 by inserting the pair of lamp pins 29 and the earth pin 30 of the straight tube type lamp 12 respectively from the distal end surfaces of the lampholders 16, 17, and rotating the straight tube type lamp 12 by 90° about the tube axis thereof.

When mounting the lamp pins 29 of the straight tube type lamp 12 into the lampholder 16 on the power supply side (see FIG. 3), the pair of lamp pins 29 of the straight tube type lamp 12 are inserted into the opening portion 50 of the case 46 from the insertion port 49 of the case 46 through the groove portions 64 of the rotating member 42 and the groove portion 60a of the supporting portions 60 of the cover 47.

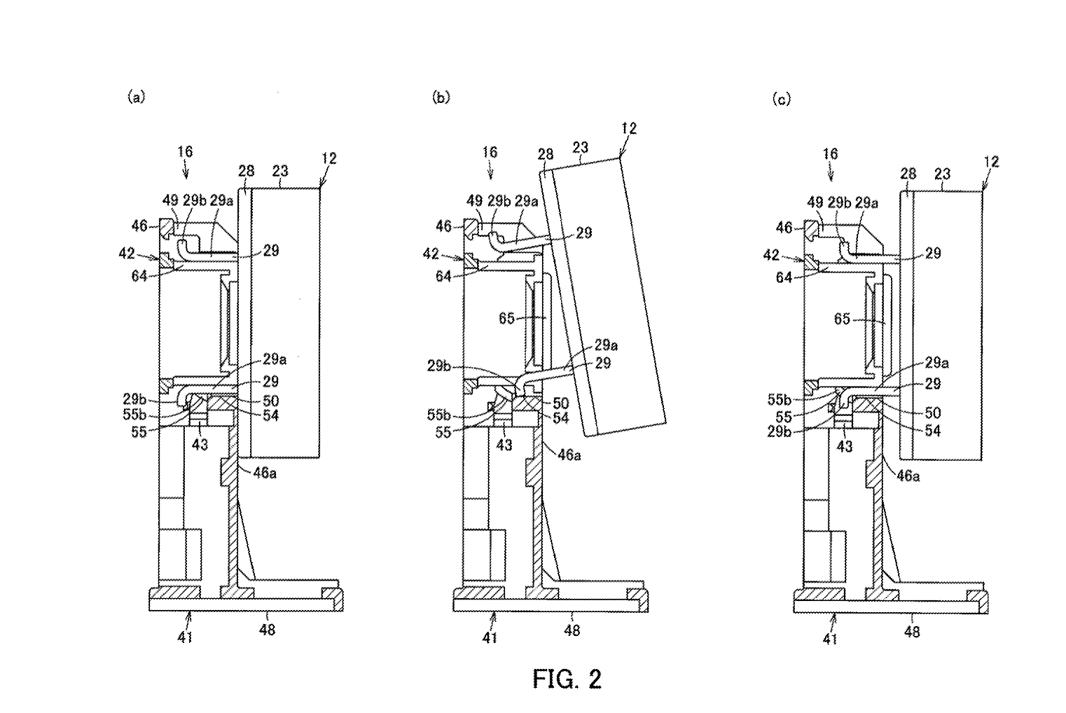

At this time, when the straight tube type lamp 12 is at the predetermined mounting position with respect to the lampholder 16 as illustrated in FIG. 2(a), the projecting portion 29b of one of the lamp pins 29 inserted from the insertion port 49 first enters the back surface side of the wall portion 54 of the case 46 to cause the leg portion 29a to abut against the wall portion 54, and the pair of lamp pins 29 are arranged in the opening portion 50 of the case 46. Therefore, the straight tube type lamp 12 is inserted into a predetermined position of insertion of the lampholder 16. At this time, the projecting ridge portion 28 projecting from the end surface of the cap 23 of the straight tube type lamp 12 is fitted between the pair of fitting projections 65 of the rotating member 42.

In this normal state of insertion, the projecting portions 29b of the pair of lamp pins 29 are arranged on the back surface side positions of the inclined portions 55 of the case 46 and on the back surface side of the hack surface side positions of the terminals 43 held, in the case 46.

Also, for example, in a state in which the straight tube type lamp 12 is inclined in a state of incomplete insertion with respect to the earth pin 30 side of the straight tube type lamp 12 or the lampholder 17, and in which the cap 23 of the straight tube type lamp 12 is significantly separated from the front surface of the lampholder body 41 of the lampholder 16 with respect to the predetermined mounting position thereof as illustrated in FIG. 2(b), the distal end of the projecting portion 29b of one of the lamp pins 29 inserted from the insertion port 49 first is restricted from abutting against the wail portion 54 of the case 46 and the straight tube type lamp 12 is restricted from being inserted into the predetermined position of insertion of the lampholder 16.

In this incomplete state of insertion, since the other lamp pin 29 which is inserted from the insertion port 49 later is positioned in the insertion port 49 and is not inserted into the opening portion 50, even when an attempt is made to rotate the straight tube type lamp 12 to mount the same in the lampholder 16, the other lamp pin 29 abuts against a portion of the case 46 which defines the insertion port 49 and resists the rotation of the straight tube type lamp 12, so that the straight tube type lamp 12 in the incomplete state of insertion is prevented from being mounted on the lampholder 16.

Also, even, when the straight tube type lamp 12 is separated from the front surface of the lampholder body 41 of the lampholder 16 with respect to the predetermined mounting position thereof as illustrated in FIG. 2(c), if the projecting portion 29b of one of the lamp pins 29 inserted from the insertion port 49 first enters to the back surface side with respect to the wall portion 54 of the case 46, the projecting portion 29b of one of the lamp pins 29 inserted from the insertion port 49 first enters the back surface side of the wall portion 54 of the case 46 and the leg portion 29a abuts against the wall portion 54. Therefore, the pair of lamp pins 29 are arranged in the opening portion 50 of the case 46, and the straight tube type lamp 12 is inserted into the predetermined position of insertion of the lampholder 16.

In this state of insertion, a rotational trajectories of the projecting portions 29b of the pair of lamp pins 29 when the straight tube type lamp 12 is rotated at this position matches an area that interferes with the inclined surfaces 55b of the inclined portions 55 of the case 46 and the terminals 43 held in the case 46.

Then, in a state in which the straight tube type lamp 12 is inserted into the predetermined position of insertion of the lampholder 16 (the state illustrated in FIG. 2(a) or (c)), the straight tube type lamp 12 can be rotated with respect to the lampholder 16.

The straight tube type lamp 12 is rotated by 90° about the tube axis thereof until a connecting position so that the direction of emission of light of the straight tube type lamp 12 is directed to a predetermined direction of irradiation. Accordingly, at least the pair of lamp pins 29 abut against the rotating member 42 on the outside of the supporting portions 60 of the cover 47 in the radial direction, and the rotating member 42 rotates together with the straight tube type lamp 12. In a state in which the straight tube type lamp 12 is at the predetermined mounting position with respect to the lampholder 16, the rotating member 42 rotates together with the straight tube type lamp 12 by the projecting ridge portion of the cap 23 coming into contact with the fitting projections 65 of the rotating member 42 in addition to the pair of lamp pins 29 abutting against the rotating member 42 on the outside of the supporting portions 60 of the cover 47 in the radial direction.

When the straight tube type lamp 12 is rotated, as illustrated in FIG. 2(a), if the straight tube type lamp 12 is at the predetermined mounting position with respect to the lampholder 16, the projecting portions 29b of the pair of lamp pins 29 more to the back surface side of the terminals 43 held within the case 46 in association with the rotation of the straight tube type lamp 12 without interfering with the inclined portions 55 of the case 46 or the terminals 43.

Also, even when the straight tube type lamp 12 is separated from the front surface of the lampholder body 41 of the lampholder 16 with respect to the predetermined mounting position thereof as illustrated in FIG. 2(c) when the straight tube type lamp 12 is rotated, if the projecting portion 29b of one of the lamp pins 29 inserted from the insertion port 49 first enters to the back surface side with respect to the wall portion 54 of the case 46, the projecting portions 29b of the pair of the lamp pins 29 abut against and run on the inclined surface 55b of the pair of inclined portions 55 of the case 46 corresponding to the direction of rotation in association with the rotation of the straight tube type lamp 12 as illustrated also in FIG. 1.

Since the inclined surfaces 55b of the inclined portions 55 project and incline toward the back surface of the case 46 along the direction of rotation of the straight tube type lamp 12, the projecting portions 29b of the pair of lamp pins 29 move toward the back surface side along the inclined surface 55b of the inclined portions 55 while rotating, and the straight tube type lamp 12 gets close to the front surface of the lampholder body 41, so that the straight tube type lamp 12 is automatically drawn into the predetermined mounting position with respect to the lampholder 16.

At this time, in a state in which the projecting portions 29b of the pair of lamp pins 29 run on the pair of inclined portions 55, the movement of the leg portions 29a of the pair of lamp pins 29 in the direction in which the pair of lamp pins 29 face each other is prevented by the rib 55a of the pair of inclined portions 55 and the edge portion of the opening portion 50, and hence the state in which the projecting portions 29b of the pair of lamp pins 29 run on the pair of inclined portions 55 is reliably maintained.

In this manner, the straight tube type lamp 12 is at the predetermined mounting position with respect to the lampholder 16, and the projecting portions 29b of the pair of lamp pins 29 move to the back surface side of the terminals 43 held within the case 46 without interfering with the terminals 43.

Then, in the course of the rotation of the straight tube type lamp 12, the leg portions 29a of the pair of lamp pins 29 come into contact with the connecting plate portion 71 of the pair of terminals 43, and resiliently deform the connecting plate portion 71 outward.

When the rotating member 42 rotates, the projecting portions 66 of the rotating member 42 come apart from the notched portions 61a of the guide wall 61 and rotate while sliding on the inner peripheral surface of the guide wall 61. When the pair of lamp pins 29 rotate to the connecting position, the projecting portions 66 of the rotating member 42 are fitted to the notched portions 61a located adjacent to the guide wall 61, so that a load is applied to the rotation of the straight tube type lamp 12 and the fact that the straight tube type lamp 12 is rotated to the connecting position is confirmed.

When the straight tube type lamp 12 is rotated to a predetermined connecting position, the groove portions 64 of the rotating member 42 move away from the position of the insertion port 49 of the case 46 and are closed by the edge portion of the opening portion 50 of the case 46, so that the pair of lamp pins 29 are prevented from coming off the insertion port 49 of the case 46. In addition, the projecting portions 29b of the pair of lamp pins 29 are arranged on the back surface side of the terminals 43 and hence the lamp pins 29 are prevented from coming off the opening portion 50 of the case 46.

Then, when the straight tube type lamp 12 is rotated to the predetermined connecting position, two corner portions on the outsides of the leg portions 29a of the pair of lamp pins 29 having a square shape in cross section come into contact with both of the inclined surfaces 74b of the terminal holding portion 74 provided on the connecting plate portions 71 of the pair of terminals 43, and the respective terminals 43 are held in a state of being in contact at two points with the respective lamp pins 29 respectively.

In contrast, as regards the earth pin 30 of the straight tube type lamp 12, the earth pin 30 of the straight tube type lamp 12 is inserted along the longitudinal, direction of the holding portion 30b of the earth pin 30, and the straight tube type lamp 12 is rotated by 90° about the tube axis thereof, so that the longitudinal direction of the holding portion 30b of the earth pin 30 turns sideways with respect to the direction of insertion into the lampholder 17, and the earth pin 30 is electrically connected to the terminal arranged in the lampholder 17 and is supported by the lampholder 17.

Then, by the operation of the lighting apparatus 18, the DC power from the lighting apparatus 18 is supplied to the light-source unit 22 through the pair of terminals 43 of the lampholder 16 on the power supply side and the pair of lamp pins 29 of the straight tube type lamp 12, so that the respective semiconductor light-emitting elements 25 of the light-source unit 22 are illuminated and light from the respective semiconductor light-emitting elements 25 passes through the translucent cover 21 and irradiated to the predetermined direction of irradiation under the luminaire 11.

When removing the straight tube type lamp 12, the straight tube type lamp 12 is rotated by 90° in the opposite direction from that performed at the time of mounting or in the same direction as that performed at the time of mounting. Accordingly, in the lampholder 16 on the power supply side, since the groove portions 64 of the rotating member 42 rotating together with the pair of lamp pins 29 match the insertion port 49 of the case 46, the pair of lamp pins 29 can be pulled out and removed through the insertion port 49 of the case 46. In contrast, in the lampholder 17 on the earth side, the longitudinal direction of the holding portion 30b of the earth pin 30 match the direction of insertion with respect to the lampholder 17, so that the earth pin 30 can be pulled out and removed from the lampholder 17.

In this manner, in the lampholder 16 on the power supply side of the embodiment, since the wall portion 54 configured to restrict the insertion of the lamp pins 29 in the state in which the straight tube type lamp 12 is significantly separated from the front surface of the lampholder body 41 of the lampholder 16 with respect to the predetermined mounting position thereof is provided at the edge portion of the opening portion 50 provided on the side opposite to the insertion port 49 of the lampholder body 41 and facing the insertion port 49, the straight tube type lamp 12 in the incomplete state of insertion is prevented from being mounted on the lampholder 16.

Also, since the inclined portions 55 projecting and inclining rearward of the lampholder body 41 corresponding to the direction of rotation of the straight tube type lamp 12 when the straight tube type lamp 12 is mounted are provided on the edge portion of the opening portion 50 of the lampholder body 41, even when the straight tube type lamp 12 is rotated in a state in which the straight tube type lamp 12 whose pair of the L-shaped lamp pins 29 are inserted into the opening portion 50 from the insertion port 49 of the lampholder body 41 is separated from the front surface of the lampholder body 41 with respect to the predetermined mounting position thereof, the projecting portions 29b of the lamp pins 29 run on the inclined portions 55 and hence the straight tube type lamp 12 can be guided to the predetermined mounting position by means of the inclined portions 55, so that the straight tube type lamp 12 can be mounted reliably at the predetermined mounting position.

Furthermore, since the inclined portions 55 are provided on both sides of the insertion port 49, the straight tube type lamp 12 can be guided to the predetermined mounting position thereof by causing the lamp pins 29 on the side of the insertion port 49 to run on the inclined portions 55.

Furthermore, since the inclined portions 55 are provided on both sides of the wall portion 54 and both sides of the insertion port 49, the straight tube type lamp 12 can be guided to the predetermined mounting position thereof by causing the pair of lamp pins 29 to run on the inclined portions 55.

Furthermore, since the portions of the inclined portions 55 projecting most to the rear of the lampholder body 41 project rearward of the lampholder body 41 beyond the terminals 43, the projecting portions 29b of the lamp pins 29 may reliably be guided to the back surface side of the terminals 43 by the inclined portions 55.

Also, in a state in which the projecting portions 29b of the pair of lamp pins 29 run on the pair of inclined portions 55, the movement of the leg portions 29a of the pair of lamp pins 29 in the direction in which the pair of lamp pins 29 face each other is prevented by the rib 55a of the pair of inclined portions 55 and the edge portion of the opening portion 50, and hence the state in which the projecting portions 29b of the pair of lamp pins 29 run on the pair of inclined portions 55 is reliably maintained.

Also, since the width of the terminal holding portion 74 located at the intermediate portion of the connecting plate portion 71 of each of the terminals 43 is set to be wider than the width of the both end sides of the terminal holding portion 74 of the connecting plate portions 71, resilient properties of the terminal holding portion 74 can be enhanced, and hence the lamp pins 29 connected to the terminal holding portion 74 can reliably be held when the width of the entire connecting plate portion 71 is increased, there is a risk of interference of the rotating projecting portions 29b of the lamp pins 29 with the connecting plate portions 7171 which may forcedly deform the terminals 43 when the straight tube type lamp 12 is mounted. However, by increasing only the width of the terminal holding portion 74 without increasing the width of areas in which the projecting portions 29b of the rotating lamp pins 29 move to the back surface side of the terminals 43 when mounting the straight tube type lamp 12, that is, areas on both ends of the terminal holding portion 74, the resilient properties for holding the lamp pins 29 is enhanced and the interference of the projecting portions 29b of the rotating lamp pins 29 with the terminals 43 may be prevented.

The terminals 43 may be enhanced in resilient properties by increasing the width on the side of the electric line connecting portion 69.

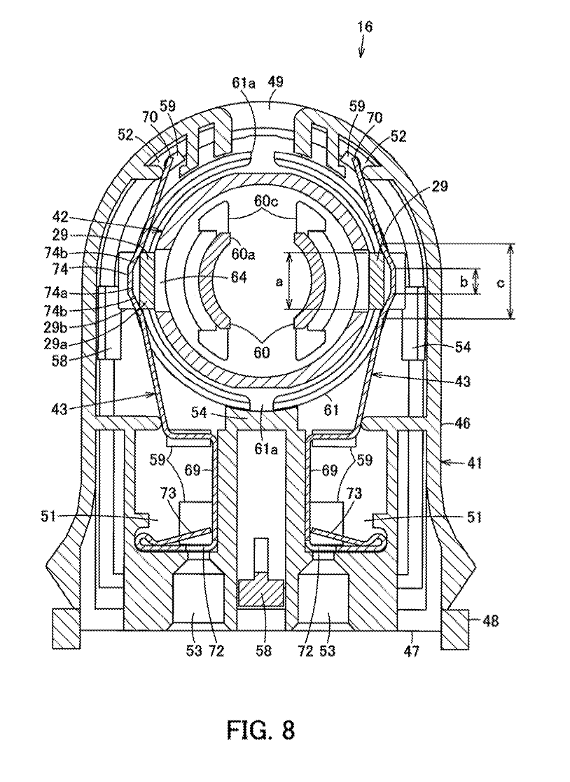

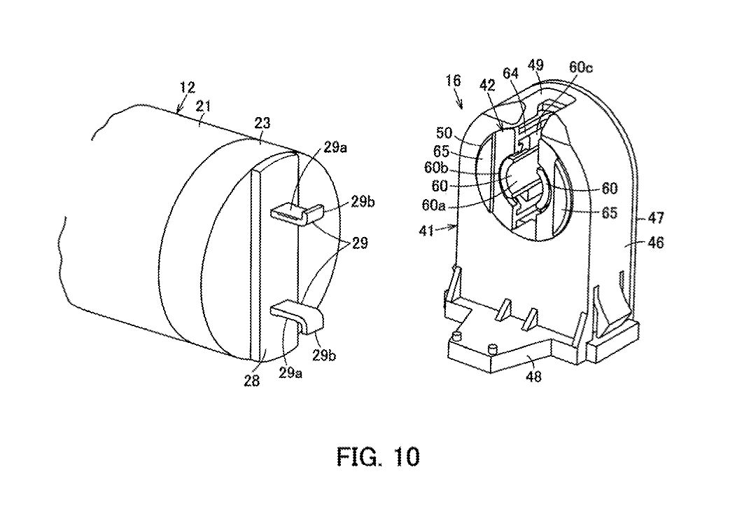

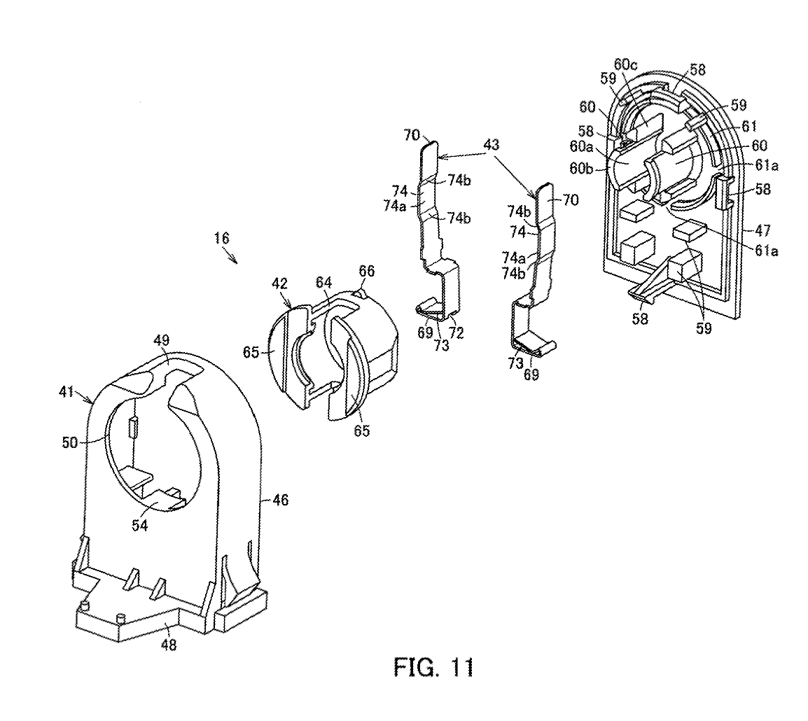

Referring now to FIG. 8 to FIG. 11, a second embodiment will be described. The same configuration as those of the first embodiment will be denoted by the same reference signs and the description thereof is omitted.

Although the wall portion 54 is provided on the edge portion of the opening portion 50 of the lampholder body 41, the inclined portions 55 are not provided thereon. The inclined portions 55 may be provided also in the second embodiment.

Stopper portions 60c projecting toward the outside in the radial direction in parallel with the groove portions 60a are formed on the pair of supporting portions 60 of the cover 47 and the diameter dimension of a virtual outer diameter circle formed by the stopper portions 60c is smaller than the opposed distance between the pair of lamp pins 29 of the straight tube type lamp 12 and is set to be approximately the same degree as the distance of the pair of lamp pins of the G13-type cap.

The width of the terminal holding portion 74 of the terminal 43 is set to be the same dimension as the width of the electric line connecting portion 69 or of the distal end portion 70. The ratio among a width a of the lamp pins 29, a width b of the inner side of the inclined surfaces 74b and a width c of the inclined surfaces 74b on the opening portion side has a relation of 4:3:4.5 and hence has a relation in which the both inclined surfaces 74b of the terminal holding portion 74 come into contact at two points with corner portions at two positions on the outside of the leg portions 29a having a square shape in cross section of the lamp pins 29 in a connecting state between the terminals 43 and the lamp pins 29.

The configuration of the lampholder 16 other than those described here are basically the same as those in the first embodiment.

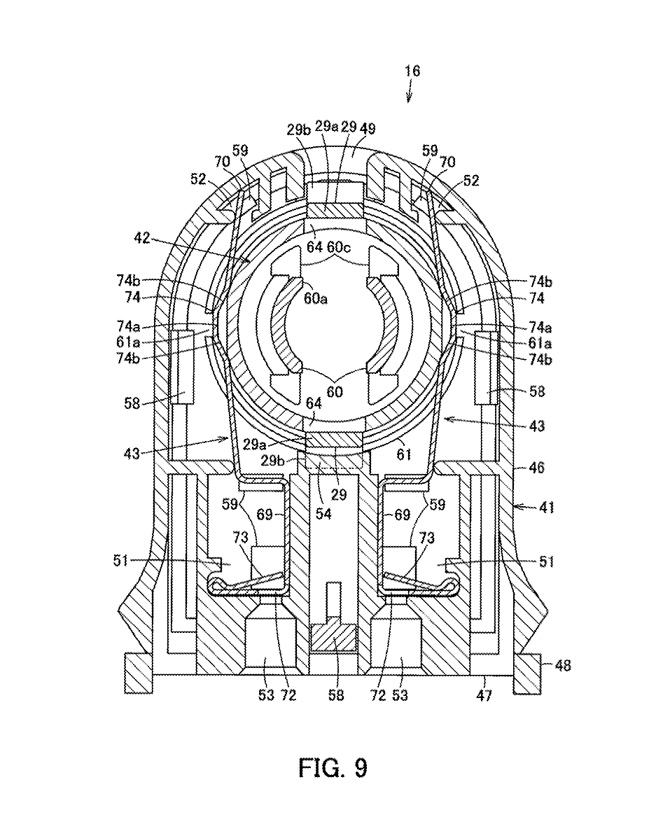

When mounting the lamp pins 29 of the straight tube type lamp 12 into the lampholder 16 for the power supply, the pair of lamp pins 29 are inserted into the groove portions 64 of the rotating member 42 and the groove portion 60a of the supporting portions 60 from the insertion port 49 of the case 46, and the leg portion 29a of one of the lamp pins 29 inserted first abuts against the wall portion 54 as illustrated in FIG. 9.

The straight tube type lamp 12 is rotated by 90° about the tube axis thereof until the connecting position so that the direction of emission of light of the straight tube type lamp 12 is directed to the predetermined direction of irradiation. At this time, if the position of insertion of the lamp pins 29 in the longitudinal direction of the straight tube type lamp 12 is not inserted to the predetermined position of the lampholder 16 or if the straight tube type lamp 12 is inclined with respect to the lampholder 16, the projecting portions 29b of the lamp pins 29 abut against the edge portion of the insertion port 49 or the stopper portions 60c of the supporting portions 60, and the rotation is restricted. Therefore, if the position of insertion of the lamp pins 29 in the longitudinal direction of the straight tube type lamp 12 is inserted to the predetermined position of the lampholder 16 and the straight tube type lamp 12 is parallel to the lampholder 16, the rotation of the straight tube type lamp 12 is allowed.

As illustrated in FIG. 8, when the straight tube type lamp 12 is rotated, the pair of lamp pins 29 come into contact with the rotating member 42 on the outside of the supporting portions 60 in the radial direction, and the rotating member 42 is rotated together with the straight tube type lamp 12.

Then, in the course of the rotation of the straight tube type lamp 12, the leg portions 29a of the pair of lamp pins 29 come into contact with the terminal holding portion 74 of the pair of terminals 43, and resiliently deform the terminal holding portion 74 outward.

When the straight, tube type lamp 12 is rotated to the connecting position, the both inclined surfaces 74b of the pair of terminals 43 come into contact respectively with the two corner portions on the outsides of the leg portions 29a of the pair of lamp pins 29 having a square shape in cross section, that is, the respective terminals 43 come in contact at two points with the respective lamp pins 29 respectively. Therefore, the electric connection between the terminals 43 and the lamp pins 29 is ensured, and the reliable power supply from the terminals 43 to the lamp pins 29 is achieved. In particular, since the DC power flowing from the terminals 43 to the lamp pins 29 is a lower current and a low voltage, if there is only one contact point, no-lighting may occur due to the contact failure. However, with the two point contact, the straight tube type lamp 12 is reliably prevented from becoming no-lighting.

The pair of lamp pins 29 of the straight tube type lamp 12 rotate together with the rotating member 42 on the outer diameter side of the supporting portions 60. Therefore, when an attempt is made to connect the G13-type cap of the straight tube type fluorescent lamp with the lampholder 16, even when an attempt is made to insert and rotate the pair of lamp pins of the G13-type cap from the insertion port 49 of the case 46, since the distance between the pair of lamp pins of the G13-type cap is smaller than the distance between the pair of lamp pins 29 of the straight tube type lamp 12, the pair of lamp pins of the G13-type cap abut against the stopper portions 60c of the supporting portions 60 and hence the G13-type cap cannot be mounted on the lampholder 16.

The terminal holding portion 74 of the terminals 43 may be of any shape such as a V-shape in cross section or an arcuate shape in cross section as long as contact at two points with the corner portions at the two positions on the outsides of the leg portion 29a of the lamp pins 29 having a square shape in cross section is achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

11 luminaire
12 straight tube type lamp
16 lampholder
29 lamp pin
29a leg portion
29b projecting portion
41 lampholder body
42 rotating member
43 terminal
49 insertion port
50 opening portion
54 wall portion
55 inclined portions

1. A lampholder for mounting a straight tube type lamp by inserting a pair of L-shaped lamp pins provided at one end of the straight tube type lamp and including a pair of leg portions and projecting portions extending outward from distal ends of the leg portions so as to be away from each other, and rotating the same comprising:
a lampholder body including: a front portion facing the straight tube type lamp when the straight tube type lamp is mounted; an insertion port provided on a surface intersecting the front portion and allow insertion of the pair of lamp pins; an opening portion provided in the front portion so as to communicate with the insertion port and configured to allow the pair of leg portions of the lamp pin to rotate; and a wall portion provided at an edge portion of the opening portion opposing the insertion port and configured to restrict insertion of the lamp pins into the opening portion in a state in which the straight tube type lamp is separated from the front portion with respect to a predetermined mounting position;
a rotating member disposed in the lampholder body and configured to rotate with respect to the lampholder body in association with the rotation of the straight tube type lamp;
a pair of terminals disposed in the lampholder body and electrically connected respectively with the pair of lamp pins.

2. The lampholder according to claim 1, wherein the lampholder body includes inclined portions provided at the edge portion of the opening portion so as to project and incline rearward of the lampholder body corresponding to the direction of rotation of the straight tube type lamp when the straight tube type lamp is mounted.

3. The lampholder according to claim 2 wherein the inclined portions are provided on both sides of the insertion port.

4. The lampholder according to claim 2, wherein a portion of the inclined portions projecting most rearward of the lampholder body projects rearward of the lampholder body beyond the terminals.

5. The lampholder according to claim 1, wherein the terminals each include one end portion and the other end portion that are held by the lampholder body, and an intermediate portion to which the lamp pin is connected and which is formed to be wider than the one end portion and the other end portion.

6. The lampholder according to claim 1, wherein the respective terminals come into contact with two positions of the leg portions of the lamp pins.

7. A luminaire comprising:
a straight tube type lamp including a pair of L-shaped lamp pins projecting from one end thereof, the L-shaped lamp pins having a pair of leg portions and a pair of projecting portions extending outward from distal ends of the leg portions so as to be away from each other;
a lampholder according to claim 1 for mounting the straight tube type lamp by inserting the pair of lamp pins and rotating the same.
